(19) United States
(12) Patent Application Publication
(10) Pub. No.: US 2018/0176280 A1
(43) Pub. Date: Jun. 21, 2018

(54) DATA COMPRESSION DEVICE AND DATA COMPRESSION APPROVAL DEVICE

(71) Applicant: NEC Corporation, Tokyo (JP)

(72) Inventor: Satoru AMANO, Tokyo (JP)

(21) Appl. No.: 15/579,900

(22) PCT Filed: Jun. 21, 2016
(86) PCT No.: PCT/JP2016/068359

§ 371 Date: Dec. 5, 2017

(30) Foreign Application Priority Data
Jun. 25, 2015 (JP) 2015-127406

(51) Int. Cl. H04L 29/06; H04L 12/811; H04L 12/24

(52) U.S. Cl. CPC H04L 65/607; H04L 47/38; H04L 65/80; H04L 41/509; H04L 41/5025; H04L 65/601; H04L 41/5009

(57) ABSTRACT

A data compression device (e.g. a server device for relaying streaming contents) determines whether or not congestion occurs in a communication network for communicating with a data compression approval device (e.g. a terminal device). Upon receiving a congestion occurrence signal and a data compression inquiry signal, the data compression approval device generates and transmits a data compression response signal to the data compression device. Upon receiving the data compression response signal, the data compression device compresses and transmits content data to the data compression approval device when it determines that congestion occurs in the communication network. Thus, even when an operator fails to confirm user's approval of compressing content data by a user's contract, it is possible to compress and transmit content data to the data compression approval device depending on the congestion in the communication network, thus suppressing congestion occurring in the communication network.

### TECHNICAL FIELD

The present invention relates to a data compression device and a data compression approval device applied to a communication system configured to relay streaming contents through networks.

The present application claims the benefit of priority on Japanese Patent Application No. 2015-127406 filed on Jun. 25, 2015, the subject matter of which is hereby incorporated herein by reference.

### BACKGROUND ART

Recently, content delivery services have been carried out to provide terminal devices with contents such as moving pictures through communication networks. Herein, compression processes have been carried out in data distribution to prevent congestion from occurring in communication networks. For example, Patent Literature 1 discloses a streaming-content providing servers for providing users with contents compressed at compression rates selected by users and a content providing system for making charges to users depending on compression rates. Patent Literature 2 discloses a data transmission system securing a real-time operation in data transmission using best-effort networks. Patent Literature 3 discloses a communication device that can transmit data without any delay while efficiently using network bands by changing compression rates depending on load factors of networks. Patent Literature 4 discloses a data delivery device configured to compress data depending on users' standby time tolerances.

### CITATION LIST

### Patent Literature Document

Patent Literature 1: Japanese Patent Application Publication No. 2003-16289

Patent Literature 2: Japanese Patent Application Publication No. 2002-330167

Patent Literature 3: Japanese Patent Application Publication No. 2002-223220

Patent Literature 4: Japanese Patent Application Publication No. 2000-295272

### SUMMARY OF INVENTION

### Technical Problem

Conventionally, content delivery systems configured to provide terminal devices with contents such as moving pictures through communication networks are equipped with relay devices such as proxy servers having functions to compress contents for the purpose of suppressing congestion occurring in communication networks. Proxy servers are designed to determine whether congestion occurs in communication networks by measuring round trip times (RTT) occurring between terminal devices and proxy servers and by measuring throughputs based on the amount of data transmitted from proxy servers to terminal devices. Upon determining the occurrence of congestion in communication networks, proxy servers carries out data compression so as to transmit compressed data to terminal devices.

However, it is necessary to carry out compression and decompression processes in transmitting contents compressed by proxy servers to terminal devices; hence, this may cause time lags in transmitting contents. In addition, content may be degraded in quality when proxy servers carry out irreversible compression processes to compress contents such as still pictures, moving pictures, and sounds. Therefore, it is necessary to confirm users' approval for compressing contents by users' contracts in order to suppress congestion occurring in communication networks by transmitting contents compressed by proxy servers to terminal devices. In addition, proxy servers need to normally transmit contents without compression to users who have not approved compression of contents by users' contracts; hence, it is difficult to suppress congestion occurring in communication networks.

For this reason, it is necessary to develop technologies for suppressing congestion occurring in communication networks by way of proxy servers for compressing and transmitting contents to terminal devices even when their operators fail to confirm users' approval of compressing contents by users' contracts.

The present invention is made to solve the above problem, and therefore the present invention aims to provide a data compression device and a data compression approval device configured to compress data without confirming users' approval of data compression in a communication system configured to relay streaming contents through communication networks.

### Solution to Problem

A first aspect of the present invention is directed to a communication system in which a data compression device is connected to a data compression approval device through a communication network. The data compression device includes a congestion determination part configured to determine whether or not congestion occurs in the communication network before communicating with the data compression approval device, and a data compression part configured to compress content data to be transmitted from the data compression device to the data compression approval device when a data compression response signal indicating an execution/non-execution of data compression received from the data compression approval device indicates an execution of data compression when the congestion determination part determines that congestion occurs in the communication network. The data compression approval device includes a response generator configured to generate and transmit the data compression response signal to the data compression device upon receiving a congestion occurrence signal indicating the occurrence of congestion in the communication network and a data compression inquiry signal for inquiring about the execution/non-execution of data compression.

A second aspect of the present invention is directed to a data compression control method adapted to a communication system in which a data compression device is connected to a data compression approval device through a communication network. According to the data compression control method, the data compression device determines whether or not congestion occurs in the communication network for communicating with the data compression approval device, and then it generates and transmits a congestion occurrence signal indicating the occurrence of congestion and a data compression inquiry signal for inquiring about an execution/non-execution of data compression to the data compression approval device upon determining that congestion occurs in the communication network. Upon receiving the congestion occurrence signal and the data compression inquiry signal, the data compression approval device generates and transmits a data compression response signal indicating a response as to the execution/non-execution of data compression to the data compression device. Upon receiving the data compression response signal indicating the execution of data compression from the data compression approval device, the data compression device compresses and transmits content data to the data compression approval device through the communication network.

A third aspect of the present invention is directed to a program installed in a data compression device and a data compression approval device connected together through a communication network. The data compression device executes a congestion determination process for determining whether or not congestion occurs in the communication network, and a data compression process for compressing content data to be transmitted from the data compression device to the data compression approval device when a data compression response signal indicating an execution/non-execution of data compression received from the data compression approval device indicates an execution of data compression upon determining that congestion occurs in the communication network. The data compression approval device generates and transmits a data compression response signal indicating a response as to an execution/non-execution of data compression to the data compression device upon receiving a congestion occurrence signal indicating the occurrence of congestion in the communication network and a data compression inquiry signal for inquiring about the execution/non-execution of data compression from the data compression device.

### Advantageous Effects of Invention

According to the present invention, it is possible for a server device to compress and transmit content data to terminal devices depending on the congestion occurring in communication networks even when its operator fails to confirm users' approval for compressing content data by users' contracts in advance in a communication system configured to relay streaming contents; hence, it is possible to suppress congestion occurring in communication networks.

### BRIEF DESCRIPTION OF DRAWINGS

FIG. 1 is a block diagram of a communication system including a server device adopting the present invention and a terminal device connected together through a communication network.

FIG. 2 is a block diagram of a server device serving as a data compression device according to the first embodiment of the present invention.

FIG. 3 is a block diagram of a terminal device serving as a data compression approval device according to the first embodiment of the present invention.

FIG. 4 is a flowchart of a data compression control process implemented by the terminal device and the server device according to the first embodiment of the present invention.

FIG. 5 is a block diagram of a server device according to the second embodiment of the present invention.

FIG. 6 is a flowchart of a data compression control process implemented by the terminal device and the server device according to the second embodiment of the present invention.

FIG. 7 is a block diagram showing the minimum configuration of a server device serving as a data compression device according to the present invention.

FIG. 8 is a block diagram showing the minimum configuration of a terminal device serving as a data compression approval device according to the present invention.

### DESCRIPTION OF EMBODIMENTS

A data compression device and a data compression approval device according to the present invention will be described in detail by way of embodiments with reference to the accompanying drawings.

### First Embodiment

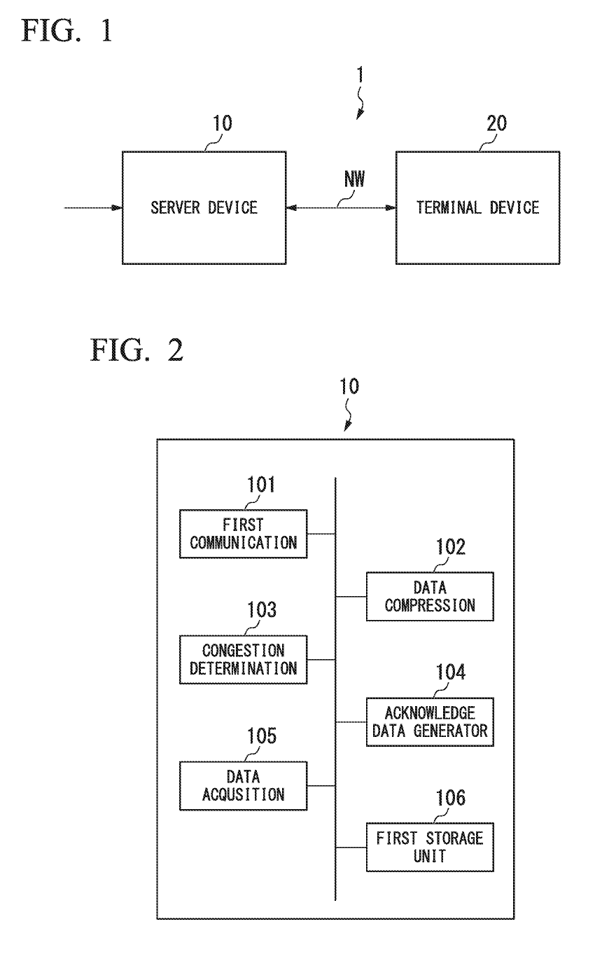

FIG. 1 is a block diagram of a communication system 1 adopting a data compression device and a data compression approval device according to the present invention. The communication system 1 includes a server device 10 and a terminal device 20. The server device 10 corresponds to the data compression device of the present invention. The terminal device 20 corresponds to the data compression approval device of the present invention. The server device 10 and the terminal device 20 are connected together through a communication network NW.

In the communication system 1, the server device 10 transmits a congestion occurrence signal (i.e. a signal representing the occurrence of congestion) and a data compression inquiry signal (i.e. an inquiry as to whether or not to carry out data compression for content data to be transmitted from the server device 10 to the terminal device 20) to the terminal device 20 when congestion occurs in the communication network NW used to carry out communication with the terminal device 20. Upon receiving the congestion occurrence signal and the data compression inquiry signal from the server device 10, the terminal device 20 replies a data compression response signal (i.e. a response as to whether or not to compress content data) to the server device 10. The server device 10 compresses content data to be transmitted to the terminal device 20 when the data compression response signal received from the terminal device 20 indicates an execution of compressing content data.

In the communication system 1 described above, the server device 10 transmits a data compression inquiry signal for content data to the terminal device 20 when it determines the occurrence of congestion in the communication network NW. The server device 10 receives a data compression response signal to the data compression inquiry signal from the terminal device 20. The server device 10 compresses content data to be transmitted to the terminal device 20 when the data compression response signal indicates an execution of compressing content data. Thus, it is possible for the server device 10 to compress and transmit content data to the terminal device 20 depending the occurrence of congestion in the communication network NW even when its operator fails to confirm user's approval of compressing content data by a user's contract. That is, it is possible to suppress congestion occurring in the communication network NW.

Next, the server device 10 corresponding to the data compression device according to the first embodiment of the present invention will be described in terms of the configuration and the function. FIG. 2 is a block diagram of the server device 10. The server device 10 includes a first communication part 101, a data compression part 102, a congestion determination part 103, an acknowledge data generator 104, a data acquisition part 105, and a first storage unit 106.

The first communication part 101 transmits a congestion occurrence signal and a data compression inquiry signal to the terminal device 20 when the congestion determination part 103 determines that congestion occurs in the communication network NW. Specifically, the first communication part 101 transmits a congestion occurrence signal and a data compression inquiry signal to the terminal device 20 when the traffic between the server device 10 and the terminal device 20 is equal to or less than a predetermined amount of data. Thereafter, the first communication part 101 receives a data compression response signal from the terminal device 20.

Upon receiving a data compression response signal representing an execution of compressing content data from the terminal device 20, the data compression part 102 compresses content data to be transmitted to the terminal device 20 when the congestion determination part 103 determines that congestion occurs in the communication network NW.

The congestion determination part 103 determines whether or not congestion occurs in the communication network NW between the server device 10 and the terminal device 20. For example, the congestion determination part 103 determines that congestion occurs in the communication network NW when the traffic between the server device 10 and the terminal device 20 is equal to or less than a predetermined amount of data. Specifically, the congestion determination part 103 measures the round trip time (RTT) for data transmission/reception between the server device 10 and the terminal device 20 in the connection of TCP (Transmission Control Protocol), i.e. a protocol in a transport layer, and a throughput based on the amount of data transmitted from the server device 10 to the terminal device 20. Herein, the congestion determination part 103 determines that congestion occurs in the communication network NW when the measured value of RTT is equal to or greater than a predetermined value and/or when the measured value of throughput is equal to or less than a predetermined value (i.e. a different value than the predetermined value relating to the RTT).

The acknowledge data generator 104 generates a congestion occurrence signal representing the occurrence of congestion in the communication network NW and a data compression inquiry signal making an inquiry as to whether or not to compress content data when the congestion determination part 103 determines that the traffic between the server device 10 and the terminal device 20 is equal to or less than the predetermined value. The acknowledge data generator 104 transmits the congestion occurrence signal and the data compression inquiry signal to the terminal device 20 through the first communication part 101.

The data acquisition part 105 acquires content data to be transmitted to the terminal device 20 from an external device (not shown) other than the terminal device 20. For example, the external device is a content delivery device configured to delivery streaming data of contents to the terminal device 20. For this reason, the data acquisition part 105 acquires streaming data of contents to be delivered to the terminal device 20 from the content delivery device.

The first storage unit 106 stores various pieces of information required for processes executed by the server device 10. For example, the first storage unit 106 stores the predetermined amount of data serving as a determination criterion for the congestion determination part 103 to determine whether or not congestion occurs in the communication network NW. In addition, the first storage unit 106 stores content data that the data acquisition part 105 acquires from the external device (e.g. the content delivery device).

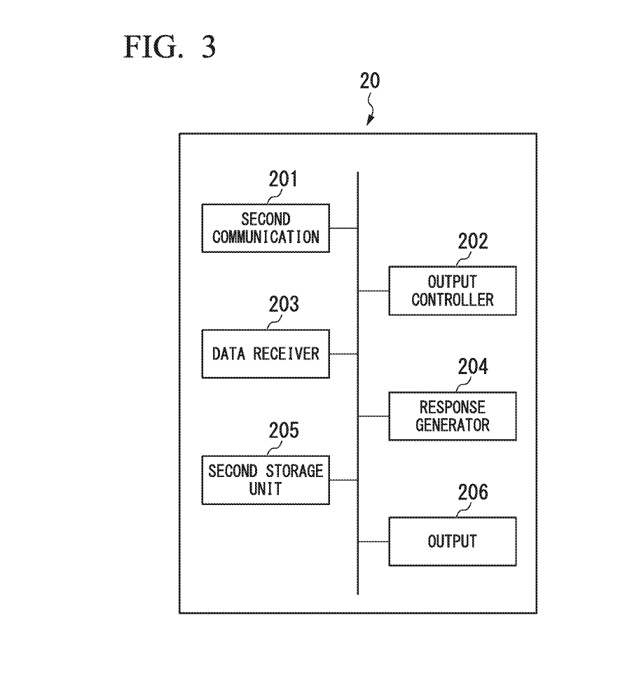

Next, the terminal device 20 configured to communicate with the server device 10 will be described in terms of the configuration and the function. FIG. 3 is a block diagram of the terminal device 20. The terminal device 20 includes a second communication part 201, an output controller 202, a data receiver 203, a response generator 204, a second storage unit 205, and an output part 206.

The second communication part 201 receives from the server device 10 a congestion occurrence signal representing the occurrence of congestion in the communication network NW between the server device 10 and the terminal device 20 and a data compression inquiry signal making an inquiry as to whether or not to compress content data. In addition, the second communication part 201 transmits to the server device 10 a data compression response signal to the data compression inquiry signal concerning an execution/non-execution of compressing content data.

The output controller 202 controls the output part 206 (e.g. a display) to output data compression acknowledge information depending on the congestion occurrence signal and the data compression inquiry signal. For example, the output controller 202 executes a specific application program and thereby controls the output part 206 to display a message (e.g. a message of “congestion occurs. Should content data be compressed?”) used to notify each user of the occurrence of congestion depending on the congestion occurrence signal. In addition, the output controller 202 controls the output part 206 to display an icon (e.g. a “compression” icon) used to instruct compression of content data to be transmitted from the server device 10 to the terminal device 20 and an icon (e.g. a “non-compression” icon) used to instruct non-compression of content data in response to the data compression inquiry signal.

For example, the data receiver 203 is a user's operation receiving means such as a touch panel, a keyboard, and a mouse. The data receiver 203 generates an input operation signal in response to a user's operation. When a user operates a “compression” icon on a touch panel, for example, the data receiver 203 generates a data compression approval signal representing user's approval of compressing content data to be transmitted to the terminal device 20. On the other hand, when a user operates a “non-compression” icon on a touch panel, the data receiver 203 generates a data compression disapproval signal representing user's disapproval of compressing content data to be transmitted from the server device 10 to the terminal device 20.

Upon receiving the congestion occurrence signal and the data compression inquiry signal from the server device 10, the response generator 204 generates a data compression response signal indicating an execution/non-execution of compressing content data. Specifically, the response generator 204 generates a data compression response signal representing an execution/non-execution of compressing content data based on an input operation signal generated by the data receiver 203 depending on a user's operation when the output controller 202 controls the output part 206 to output a data compression inquiry signal representing an execution/non-execution of compressing content data. When a user operates a “compression” icon, for example, the response generator 204 generates a data compression approval response signal indicating compression of content data based on a data compression approval signal (i.e. user's approval of compressing content data to be transmitted from the server device 10 to the terminal device 20) generated by the data receiver 203. In addition, the response generator 204 transmits a data compression response signal (e.g. a data compression approval response signal) to the server device 10. Specifically, the response generator 204 transmits a data compression response signal concerning an execution/non-execution of compressing content data to the server device 10 through the second communication part 201.

The second storage unit 205 stores various pieces of information required for processes executed by the terminal device 20. For example, the second storage unit 205 stores a specific application program executed by the output controller 202. In addition, the output part 206 outputs various pieces of information under the control of the output controller 202.

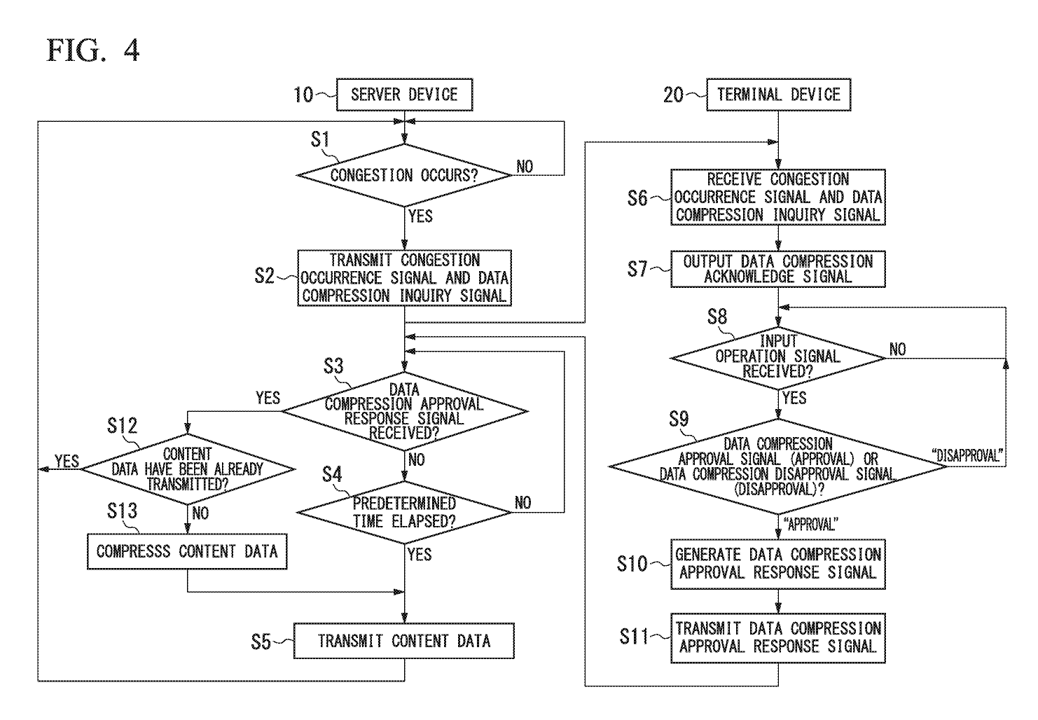

Next, a data compression control process executed by the server device 10 and the terminal device 20 in the communication system 1 will be described with reference to the flowchart of FIG. 4. Herein, the server device 10 has the configuration of FIG. 2 while the terminal device 20 has the configuration of FIG. 3. In this connection, the server device 10 has a function of a relay device for suppressing congestion occurring in the communication network NW when the content delivery device delivers contents such as moving pictures to the terminal device 20.

First, the data acquisition part 105 of the server device 10 receives content data (i.e. non-compressed data), which are delivered from the external device (e.g. the content delivery device) to the terminal device 20, through the first communication part 106. The congestion determination part 103 determines whether or not congestion occurs in the communication network NW between the server device 10 and the terminal device 20 while the data acquisition part 105 carries out a reception process for content data (step S1). For example, the congestion determination part 103 determines that congestion occurs in the communication network NW when the traffic flowing between the server device 10 and the terminal device 20 is equal to or less than the predetermined amount of data. Specifically, the congestion determination part 103 measures the round trip time (RTT) for data transmission/reception between the server device 10 and the terminal device 20 in the TCP connection concerning the transport-layer protocol and a throughput based on the amount of data transmitted from the server device 10 to the terminal device 20. Herein, the congestion determination part 103 determines that congestion occurs in the communication network NW when the measured value of RTT is equal to or greater than the predetermined value and/or when the measured value of throughput is equal to or less than the predetermined value (i.e. a different value than the predetermined value concerning the RTT). In addition, the congestion determination part 103 determines that congestion does not occur in the communication network NW when the traffic between the server device 10 and the terminal device 20 exceeds the predetermined amount of data.

In the flowchart of FIG. 4, the congestion determination part 103 carries out a determination process of step S1 again after lapse of a predetermined time when it determines that congestion does not occur in the communication network NW connected between the server device 10 and the terminal device 20 (i.e. a determination result “NO” in step S1). In addition, the congestion determination part 103 sends a congestion occurrence notification signal used to notify the occurrence of congestion to the acknowledge data generator 104 when it determines that congestion occurs in the communication network NW (i.e. a determination result “YES” of step S1).

The acknowledge data generator 104 generates a congestion occurrence signal indicating the occurrence of congestion in the communication network NW connected between the server device 10 and the terminal device 20 and a data compression inquiry signal used to inquiry each user about an execution/non-execution of compressing content data in response to the congestion occurrence notification signal received from the congestion determination part 103. In this connection, the data compression inquiry signal includes an identifier as to which content data an inquiry is made for. The acknowledge data generator 104 transmits the congestion occurrence signal and the data compression inquiry signal to the terminal device 20 through the first communication part 106 (step S2).

The terminal device 20 transmits to the server device 10 a data compression approval response signal indicating user's approval of compressing content data in response to the congestion occurrence signal and the data compression inquiry signal transmitted from the server device 10. In the server device 10, the data compression part 102 determines whether or not to receive a data compression approval response signal from the terminal device 20 in each unit of time interval (step S3).

The data compression part 102 determines whether or not a predetermined time has elapsed (step S4) when it does not receive a data compression approval response signal from the terminal device 20 (i.e. a determination result “NO” in step S3). Herein, the predetermined time is longer than each unit of time interval. The processing returns to step S3 when the data compression part 102 determines that the predetermined time has not elapsed (i.e. a determination result “NO” in step S4). Upon determining that the predetermined time has elapsed (i.e. a determination result “YES” in step S4), the data compression part 102 transmits content data without compression to the terminal device 20 (step S5). Thereafter, the processing returns to step S1.

In the terminal device 20, the output controller 202 receives a congestion occurrence signal and a data compression inquiry signal transmitted from the server device 10 through the second communication part 205 (step S6). The output controller 202 controls the output part 206 to output data compression acknowledge information depending on the congestion occurrence signal and the data compression inquiry signal (step S7). For example, the output controller 202 executes a specific application program and thereby controls the output part 206 to output a message for notifying the occurrence of congestion, e.g. “Congestion occurs. Should content data be compressed?” In addition, the output controller 202 controls the output part 206 to display a “compression” icon indicating compression of content data to be transmitted from the server device 10 to the terminal device 20 and a “non-compression” icon indicating non-compression of content data.

A user may operate the data receiver 203 to indicate an execution/non-execution of compressing content data depending on the data compression acknowledge information outputted with the output part 206. In this case, the data receiver 203 generates an input operation signal indicating an execution/non-execution of compressing content data depending on a user's input operation. When a user operates the “compression” icon, for example, the data receiver 203 generates a data compression approval signal for approving compression of content data to be transmitted from the server device 10 to the terminal device 20. On the other hand, when a user operates the “non-compression” icon, the data receiver 203 generates a data compression disapproval signal for disapproving compression of content data to be transmitted from the server device 10 to the terminal device 20. The data receiver 203 sends an input operation signal (i.e. a data compression approval signal or a data compression disapproval signal) to the response generator 204. On the other hand, when a user does not carry out an input operation indicating an execution/non-execution of compressing content data with the data receiver 203, the data receiver 203 does not send an input operation signal.

The response generator 204 determines whether or not it receives an input operation signal from the data receiver 203 (step S8). The determination process of step S8 will be repeated when the response generator 204 does not receive an input operation signal from the data receiver 203 (i.e. a determination result “NO” in step S8). On the other hand, when the response generator 204 receives an input operation signal from the data receiver 203 (i.e. a determination result “YES” in step S8), it determines whether the input operation signal is either the data compression approval signal or the data compression disapproval signal (step S9).

The processing returns to step S8 when the response generator 204 determines that the input operation signal is the data compression disapproval signal (i.e. a determination result “disapproval” in step S9). On the other hand, the response generator 204 generates a data compression approval response signal (step S10) when it determines that the input operation signal is the data compression approval signal (i.e. a determination result “approval” in step S9). In this connection, the data compression approval response signal includes an identifier indicating which content data the response is made for. The response generator 204 transmits the data compression approval response signal to the server device 10 through the second communication part 201 (step S11).

In the server device 10, the data compression part 102 determines whether or not the content data indicated by the identifier included in the data compression approval response signal have been already transmitted to the terminal device 20 (step S12) when it receives the data compression approval response signal from the terminal device 20 (i.e. a determination result “YES” in step S3). The processing returns to step S1 when the data compression part 102 determines that the content data indicated by the identifier included in the data compression approval response signal have been already transmitted to the terminal device 20 (i.e. a determination result “YES” in step S12). On the other hand, the data compression part 102 compresses the content data to be transmitted from the server device 10 to the terminal device 20 (step S13) when it determines that the content data indicated by the identifier included in the data compression approval response signal have not been transmitted to the terminal device 20 (i.e. a determination result “NO” in step S12). The data compression part 102 transmits the compressed content data to the terminal device 20 through the first communication part 106 (step S5).

The first embodiment of the present invention is designed to carry out a data compression control process shown in FIG. 4 in the communication system 1. The communication system 1 includes the server device 10 and the terminal device 20, wherein the server device 10 includes the data compression part 102 and the congestion determination part 103. The congestion determination part 103 determines whether or not congestion occurs in the communication network NW connected between the server device 10 and the terminal device 20. The data compression part 102 compresses the content data to be transmitted from the server device 10 to the terminal device 20 when the data compression part 102 receives a response indicating an execution of compression with respect to an execution/non-execution of compressing content data from the terminal device 20 when the congestion determination part 103 determines that congestion occurs in the communication network NW. The terminal device 20 includes the response generator 204. The response generator 204 generates a data compression response signal indicating an execution/non-execution of content data when it receives from the server device 10 a congestion occurrence signal indicating the occurrence of congestion in the communication network NW and a data compression inquiry signal for inquiring about an execution/non-execution of compressing content data. The response generator 204 transmits the data compression response signal to the server device 10.

Thus, even when an operator fails to confirm user's approval of compressing content data by a user's contract, it is possible for the server device 10 to compress and transmit content data to the terminal device 20 depending on the occurrence of congestion, and therefore it is possible to suppress congestion occurring in the communication network NW. In this connection, the communication system 1 is not necessarily limited to a single terminal device 20 communicating with the server device 10 through the communication network NW; hence, it is possible to provide a plurality of terminal devices 20. When the server device 10 communicates with multiple terminal devices 20 through the communication network NW, the acknowledge data generator 104 of the server device 10 may transmit a congestion occurrence signal and a data compression inquiry signal to each of multiple terminal devices 20 in step S2 of the data compression control process of FIG. 4.

### Second Embodiment

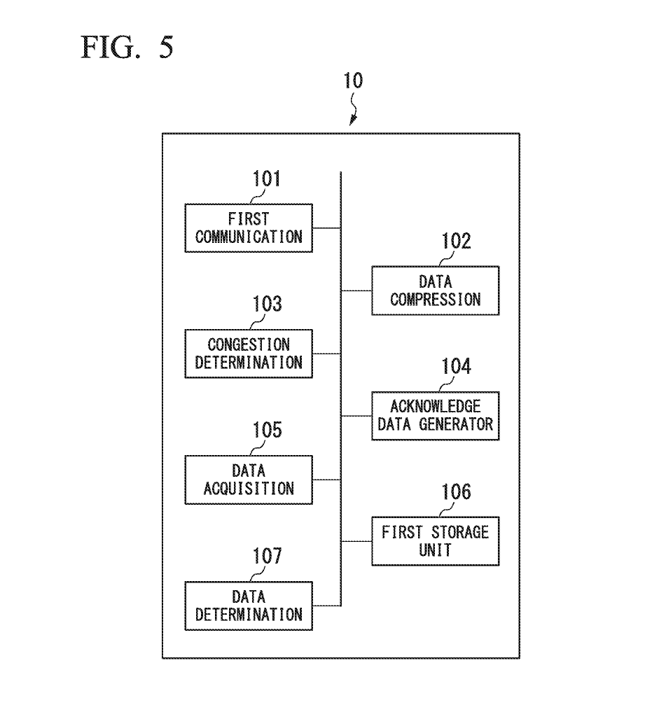

The second embodiment of the present invention will be described below. Similar to the first embodiment, the second embodiment provides the communication system 1 with the server device 10 and the terminal device 20. FIG. 5 is a block diagram of the server device 10 corresponding to a data compression device according to the second embodiment of the present invention. Compared with the server device 10 (see FIG. 2) of the first embodiment, the server device 10 of the second embodiment further includes a determination part 107. The terminal device 20 of the second embodiment is identical to the terminal device 20 of the first embodiment.

The data determination part 107 determines whether or not the content data to be transmitted from the server device 10 to the terminal device 20 are commensurate with the predetermined content data. For example, the predetermined content data can be regarded as content data having a large amount of data or content data not requiring emergency in data transmission. Herein, an effect of suppressing congestion would be expected for the content data having a large amount of data subjected to data compression. In addition, the content data not requiring emergency in data transmission can be regarded as data not requiring emergency different from emergent earthquake early warning and any other data possibly concerning human lives used for police stations and fire stations.

The acknowledge data generator 104 receives a congestion occurrence notification signal from the congestion determination part 103 while receiving an identifier of content data from the data determination part 107. The acknowledge data generator 104 generates a congestion occurrence signal representing the occurrence of congestion in the communication network NW connected between the server device 10 and the terminal device 20 and a data compression inquiry signal inquiring each user about an execution/non-execution of compressing content data in response to the congestion occurrence notification signal and the identifier of content data.

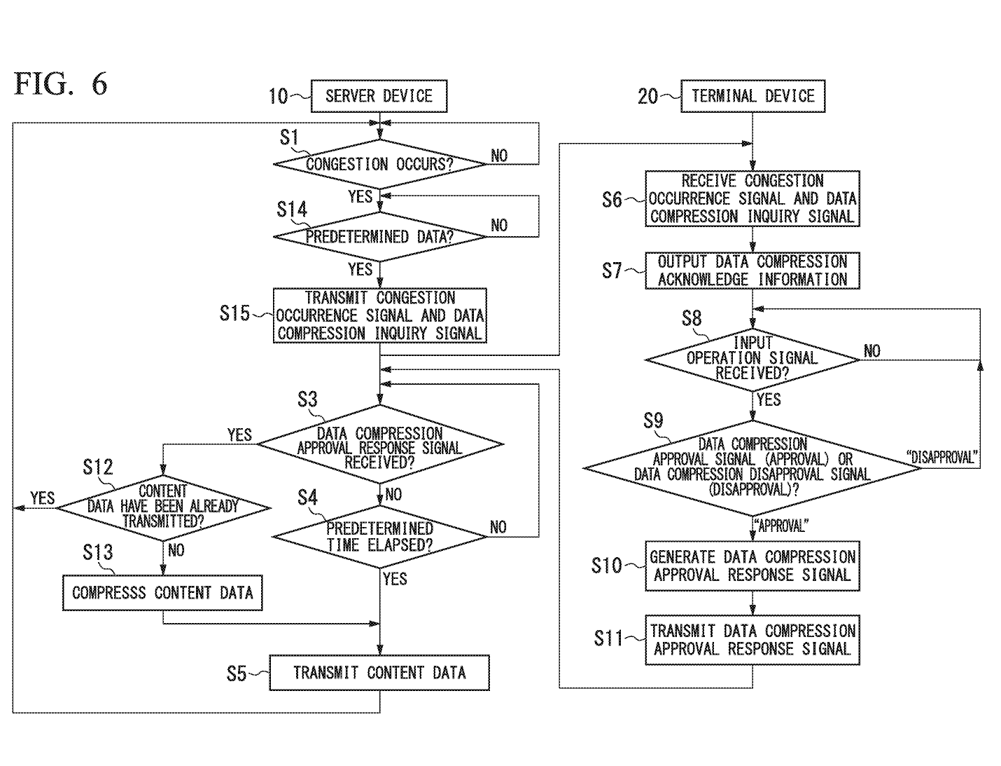

Next, a data compression control process executed by the server device 10 and the terminal device 20 in the communication system 1 will be described below. FIG. 6 is a flowchart of the data compression control process executed by the server device 10 and the terminal device 20 according to the second embodiment of the present invention. In this connection, the server device 10 has the configuration shown in FIG. 5 while the terminal device 20 has the configuration shown in FIG. 3. The server device 10 has the function of a relay device for suppressing congestion occurring in the communication network NW when the content delivery device delivers contents such as moving pictures to the terminal device 20.

The data compression control process of the second embodiment (FIG. 6) is roughly identical to the data compression control process of the first embodiment (FIG. 4), but they differ from each other in that step S2 is replaced with steps S14 and S15. For this reason, the following description refers to differences between the data compression control process of the second embodiment and the data compression control process of the first embodiment.

In the server device 10, the data determination part 107 determines whether or not the content data to be transmitted from the server device 10 to the terminal device 20 are commensurate with the predetermined content data (step S14) when the congestion determination part 103 determines that congestion occurs in the communication network NW (i.e. a determination result “YES” in step S1). Upon determining that the content data are commensurate with the predetermined content data, the data determination part 107 sends its identifier to the acknowledge data generator 104.

The acknowledge data generator 104 receives a congestion occurrence notification signal from the congestion determination part 103 while receiving an identifier of content data from the data determination part 107. The acknowledge data generator 104 generates a congestion occurrence signal representing the occurrence of congestion in the communication network NW and a data compression inquiry signal inquiring each user about an execution/non-execution of compressing content data in response to the congestion occurrence notification signal and the identifier of content data. The acknowledge data generator 104 transmits the congestion occurrence signal and the data compression inquiry signal to a destination of transmission indicated by the identifier of content data (i.e. the terminal device 20) (step S15). Thereafter, the server device 10 executes a series of steps following step S3 while the terminal device 20 executes a series of steps following step S6.

As descried above, the communication system 1 adopting the second embodiment of the present invention includes the server device 10 and the terminal device 20, wherein the server device 10 includes the data compression part 102 and the congestion determination part 103. The congestion determination part 103 determines whether or not congestion occurs in the communication network NW connected between the server device 10 and the terminal device 20. The data compression part 102 receives a data compression response signal indicating an execution/non-execution of compressing content data from the terminal device 20 when the congestion determination part 103 determines that congestion occurs in the communication network NW. Upon receiving a data compression approval response signal indicating user's approval of compressing content data from the terminal device 20, the data compression part 102 compresses content data. In addition, the terminal device 20 includes the response generator 204, which generates a data compression response signal indicating an execution/non-execution of compressing content data when receiving the congestion occurrence signal and the data compression inquiry signal from the server device 10. The response generator 204 transmits the data compression response signal (e.g. a data compression approval response signal) to the server device 10.

Thus, even when an operator fails to confirm user's approval of compressing content data by a user's contract, it is possible to compress and transmit content data to the terminal device 20 depending on the congestion condition of the server device 10, and therefore it is possible to suppress congestion occurring in the communication network NW.

In the server device 10, the data determination part 107 determines whether or not the content data to be transmitted from the server device 10 to the terminal device 20 are commensurate with the predetermined content data. The acknowledge data generator 104 receives the congestion occurrence notification signal from the congestion determination part 103 while receiving the identifier of content data from the data determination part 107. The acknowledge data generator 104 generates a congestion occurrence signal representing the occurrence of congestion in the communication network NW and a data compression inquiry signal inquiring a user about an execution/non-execution of compressing content data in response to the congestion occurrence notification signal and the identifier of content data. Thus, it is possible to selectively carry out data compression for content data having a large amount of data, and therefore it is expected to suppress congestion occurring in the communication network NW. According to the second embodiment of the present invention, it is possible for the server device 10 to reduce burdens of data compression processes, and therefore it is expected to increase data transfer speed for transferring content data having a large amount of data. In addition, it is possible to prioritize and transmit data requiring emergency in data transmission such as emergent earthquake early waning and other data possibly concerning human lives used for police stations and fire stations.

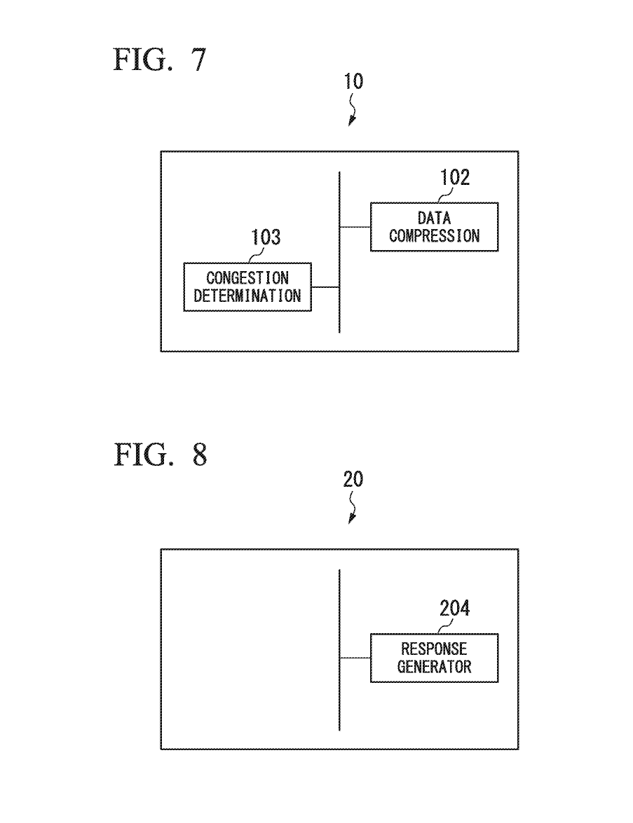

Next, the minimum configuration of the server device 10 corresponding to the data compression device according to the present invention will be described below. FIG. 7 is a block diagram showing the minimum configuration of the server device 10. The server device 10 includes the data compression part 102 and the congestion determination part 103. The congestion determination part 103 determines whether or not congestion occurs in the communication network NW connected between the server device 10 and the terminal device 20. The data compression part 102 receives a data compression response signal indicating an execution/non-execution of compressing content data from the terminal device 20 when the congestion determination part 103 determines that congestion occurs in the communication network NW. Upon receiving a data compression approval response signal indicating user's approval of compressing content data, the data compression part 102 compresses content data to be transmitted from the server device 10 to the terminal device 20.

Next, the minimum configuration of the terminal device 20 corresponding to the data compression approval device according to the present invention will be described below. FIG. 8 is a block diagram showing the minimum configuration of the terminal device 20. The terminal device 20 includes the response generator 204. The response generator 204 receives from the server device 10 a congestion occurrence signal indicating the occurrence of congestion in the communication network NW and a data compression inquiry signal inquiring a user about an execution/non-execution of compressing content data. The response generator 204 generates a data compression response signal indicating an execution/non-execution of compressing content data in response to the congestion occurrence signal and the data compression inquiry signal. The response generator 204 transmits the data compression response signal to the server device 10.

In this connection, the first storage unit 106 and the second storage unit 205 are not necessarily installed in the server device 10 and the terminal device 20; hence, they can be installed at appropriate positions within the transmittable/receivable range. In addition, it is possible to distribute and store data on multiple sets of the first and second storage units 106 and 205. In addition, the data compression control processes shown in FIGS. 4 and 6 are illustrative and not restrictive. That is, it is possible to appropriately change sequences of processes in the data compression control processed executed by the server device 10 and the terminal device 20, or it is possible to appropriately change the details of processes.

The present invention has been described by way of the first and second embodiments, wherein each of the server device 10 and the terminal device 20 includes a computer system therein. The foregoing processes are stored as programs in computer-readable storage media; hence, a computer may read and execute programs from storage media so as to achieve the foregoing processes. Herein, computer-readable storage media refer to magnetic disks, magneto-optical disks, CD-ROM, DVD-ROM, and semiconductor memory etc. In addition, it is possible to deliver computer programs to a computer through communication lines, and therefore the computer may execute programs.

Moreover, the foregoing programs may achieve part of functions corresponding to the data compression device and the data compression approval device according to the present invention. Alternatively, the foregoing programs may be so-called differential programs (or differential files), which can be combined with pre-installed programs of a computer system so as to achieve the functionality of the present invention.

The subject matter of the present invention is defined in the appended claims, which may embrace the following technical features.

(1) A communication system is designed such that a data compression device is connected to a data compression approval device through a communication network. The data compression device includes a congestion determination part configured to determine whether or not congestion occurs in the communication network before communicating with the data compression approval device, and a data compression part configured to compress and transmit content data to the data compression approval device when a data compression response signal indicating an execution/non-execution of data compression received from the data compression approval device indicates an execution of data compression when the congestion determination part determines that congestion occurs in the communication network. In addition, the data compression approval device includes a response generator configured to generate and transmit the data compression response signal to the data compression device upon receiving a congestion occurrence signal indicating the occurrence of congestion in the communication network and a data compression inquiry signal for inquiring about the execution/non-execution of data compression.
(2) In the above communication system, the data compression device further includes an acknowledge data generator configured to generate and transmit the data compression inquiry signal to the data compression approval device when the congestion determination part determines that traffic of the communication network is equal to or less than the predetermined amount of data.
(3) In the above communication system, the data compression device further includes a data determination part configured to determine whether or not the content data to be transmitted to the data compression approval device through the communication network are commensurate with the predetermined data, wherein the acknowledge data generator generates and transmits the data compression inquiry signal to the data compression approval device when the date determination part determines that the content data are commensurate with the predetermined data.
(4) A data compression device includes a congestion determination part configured to determine whether or not congestion occurs in a communication network connected to a data compression approval device, and a data compression part configured to compress and transmit content data to the data compression approval device through the communication network when a data compression response signal indicating an execution/non-execution of data compression received from the data compression approval device indicates an execution of data compression when the congestion determination part determines that congestion occurs in the communication network.
(5) The above data compression device further includes an acknowledge data generator configured to generate and transmit a data compression inquiry signal to the data compression approval device when the congestion determination part determines that traffic of the communication network is equal to or less than the predetermined amount of data.
(6) The above data compression device further includes a data determination part configured to determine whether or not the content data to be transmitted to the data compression approval device through the communication network are commensurate with the predetermined data. The acknowledge data generator generates and transmits a data compression inquiry signal to the data compression approval device when the date determination part determines that the content data are commensurate with the predetermined data
(7) A data compression approval device includes a response generator configured to generate and transmit a data compression response signal indicating an execution/non-execution of data compression to the data compression device upon receiving a congestion occurrence signal indicating the occurrence of congestion in the communication network and a data compression inquiry signal for inquiring about the execution/non-execution of data compression.
(8) A data compression control method is adapted to a communication system in which a data compression device is connected to a data compression approval device through a communication network. According to the data compression control method, the data compression device determines whether or not congestion occurs in the communication network for communicating with the data compression approval device, and then upon determining that congestion occurs in the communication network, it transmits a congestion occurrence signal indicating the occurrence of congestion and a data compression inquiry signal for inquiring about an execution/non-execution of data compression to the data compression approval device. Upon receiving the congestion occurrence signal and the data compression inquiry signal, the data compression approval device generates and transmits a data compression response signal indicating a response as to the execution/non-execution of data compression. In addition, upon receiving the data compression response signal indicating an execution of data compression from the data compression approval device, the data compression device compresses and transmits content data to the data compression approval device through the communication network.
(9) A data compression control method is adapted to a data compression device connected to a data compression approval device through a communication network. According to the data compression control method, the data compression device determines whether or not congestion occurs in the communication network, and then upon determining that congestion occurs in the communication network, it compresses and transmits content data to the data compression approval device when a data compression response signal indicating an execution/non-execution of data compression received from the data compression approval device indicates an execution of data compression.
(10) A data compression control method is adapted to a data compression approval device connected to a data compression device through a communication network. According to the data compression control method, the data compression approval device generates and transmits a data compression response signal indicating a response as to an execution/non-execution of data compression to the data compression device upon receiving a congestion occurrence signal indicating the occurrence of congestion in the communication network and a data compression inquiry signal for inquiring about the execution/non-execution of data compression from the data compression device.
(11) A program is installed in a data compression device connected to a data compression approval device through a communication network According to the program, the data compression device executes a congestion determination process for determining whether or not congestion occurs in the communication network, and a data compression process for compressing content data to be transmitted from the data compression device to the data compression approval device when a data compression response signal indicating an execution/non-execution of data compression received from the data compression approval device indicates an execution of data compression upon determining that congestion occurs in the communication network.
(12) A program is installed in a data compression approval device connected to a data compression device through a communication network. According to the program, the data compression approval device executes a response generation process for generating and transmitting a data compression response signal indicating a response as to an execution/non-execution of data compression to the data compression device upon receiving a congestion occurrence signal indicating the occurrence of congestion in the communication network and a data compression inquiry signal for inquiring about the execution/non-execution of data compression from the data compression device.

Lastly, the present invention is not necessarily limited to the foregoing embodiments and variations; hence, it is possible to appropriately change, modify, add, or delete constituent elements and functions within the range not departing from the scope of the invention as defined in the appended claims.

### INDUSTRIAL APPLICABILITY

The present invention relates to a technology of compressing contents upon receiving user's approval of data compression in a communication system for relaying streaming contents depending on congestion conditions of communication networks; but this is not a restriction. For example, the present invention is applicable to compression of any data other than contents and any types of communication systems for carrying out data compression at any facilities other than server devices for relaying streaming data.

### REFERENCE SIGNS LIST

1 communication system
10 server device (data compression device)
20 terminal device (data compression approval device)
101 first communication part
102 data compression part
103 congestion determination part
104 acknowledge data generator
105 data acquisition part
106 first storage unit
107 data determination part
201 second communication part
202 output controller
203 data receiver
204 response generator
205 second storage unit
206 output part
NW communication network

1. A communication system in which a data compression device is connected to a data compression approval device through a communication network,
wherein the data compression device comprises a congestion determination part configured to determine whether or not congestion occurs in the communication network before communicating with the data compression approval device, and
a data compression part configured to compress content data to be transmitted from the data compression device to the data compression approval device when a data compression response signal indicating an execution/non-execution of data compression received from the data compression approval device indicates an execution of data compression when the congestion determination part determines that congestion occurs in the communication network, and
wherein the data compression approval device comprises a response generator configured to generate and transmit the data compression response signal to the data compression device upon receiving a congestion occurrence signal indicating occurrence of congestion in the communication network and a data compression inquiry signal for inquiring about the execution/non-execution of data compression.

2. The communication system according to claim 1, wherein the data compression device further comprises an acknowledge data generator configured to generate and transmit the data compression inquiry signal to the data compression approval device when the congestion determination part determines that traffic of the communication network is equal to or less than a predetermined amount of data.

3. The communication system according to claim 2, wherein the data compression device further comprises a data determination part configured to determine whether or not the content data to be transmitted to the data compression approval device through the communication network are commensurate with predetermined data, and wherein the acknowledge data generator generates and transmits the data compression inquiry signal to the data compression approval device when the date determination part determines that the content data are commensurate with the predetermined data.

4. A data compression device comprising:
a congestion determination part configured to determine whether or not congestion occurs in a communication network connected to a data compression approval device; and
a data compression part configured to compress content data to be transmitted to the data compression approval device through the communication network when a data compression response signal indicating an execution/non-execution of data compression received from the data compression approval device indicates an execution of data compression when the congestion determination part determines that congestion occurs in the communication network.

5. A data compression approval device comprising:
a response generator configured to generate and transmit a data compression response signal indicating an execution/non-execution of data compression to the data compression device upon receiving a congestion occurrence signal indicating occurrence of congestion in the communication network and a data compression inquiry signal for inquiring about the execution/non-execution of data compression.

6. A data compression control method adapted to a communication system in which a data compression device is connected to a data compression approval device through a communication network, comprising:
determining by the data compression device whether or not congestion occurs in the communication network for communicating with the data compression approval device;
transmitting a congestion occurrence signal indicating occurrence of congestion and a data compression inquiry signal for inquiring about an execution/non-execution of data compression to the data compression approval device upon determining that congestion occurs in the communication network;
upon receiving the congestion occurrence signal and the data compression inquiry signal with the data compression approval device, generating and transmitting a data compression response signal indicating a response as to the execution/non-execution of data compression; and
upon receiving by the data compression device the data compression response signal indicating an execution of data compression from the data compression approval device, compressing content data to be transmitted to the data compression approval device through the communication network.

7. A data compression control method adapted to a data compression device connected to a data compression approval device through a communication network, comprising:
determining whether or not congestion occurs in the communication network; and
compressing content data to be transmitted from the data compression device to the data compression approval device when a data compression response signal indicating an execution/non-execution of data compression received from the data compression approval device indicates an execution of data compression upon determining that congestion occurs in the communication network.

8. A data compression control method adapted to a data compression approval device connected to a data compression device through a communication network, comprising:
generating and transmitting a data compression response signal indicating a response as to an execution/non-execution of data compression to the data compression device upon receiving a congestion occurrence signal indicating occurrence of congestion in the communication network and a data compression inquiry signal for inquiring about the execution/non-execution of data compression from the data compression device.

9. A non-transitory computer readable medium having stored a program causing a computer of a data compression device connected to a data compression approval device through a communication network to implement:
a congestion determination process for determining whether or not congestion occurs in the communication network; and
a data compression process for compressing content data to be transmitted from the data compression device to the data compression approval device when a data compression response signal indicating an execution/non-execution of data compression received from the data compression approval device indicates an execution of data compression upon determining that congestion occurs in the communication network.

10. A non-transitory computer-readable storage medium having stored a program causing a computer of a data compression approval device connected to a data compression device through a communication network to implement:
a response generation process for generating and transmitting a data compression response signal indicating a response as to an execution/non-execution of data compression to the data compression device upon receiving a congestion occurrence signal indicating occurrence of congestion in the communication network and a data compression inquiry signal for inquiring about the execution/non-execution of data compression from the data compression device.
